(19) United States
(12) Patent Application Publication
(10) Pub. No.: US 2013/0163872 A1
(43) Pub. Date: Jun. 27, 2013

(54) Method, Server, Reading Terminal and System for Processing Electronic Document

(71) Applicants: Peking University Founder Group Co., Ltd., Beijing (CN); Beijing Founder Apabi Technology Ltd., Beijing (CN); Founder Mobile Media Technology (Beijing) Co., Ltd., Beijing (CN); Founder Information Industry Holdings Co., Ltd., Beijing (CN)

(72) Inventors: Changqiao WANG, Beijing (CN); Peng LI, Beijing (CN); Yao DUAN, Beijing (CN); Jiale GUO, Beijing (CN)

(73) Assignees: PEKING UNIVERSITY FOUNDER GROUP CO., LTD., Beijing (CN); FOUNDER INFORMATION INDUSTRY HOLDINGS CO., LTD., Beijing (CN); FOUNDER MOBILE MEDIA TECHNOLOGY (BEIKING) CO., LTD., Beijing (CN); BEIJING FOUNDER APABI TECHNOLOGY LTD., Beijing (CN)

(21) Appl. No.: 13/728,237

(22) Filed: Dec. 27, 2012

(30) Foreign Application Priority Data
Dec. 27, 2011 (CN) 201110445056.4

(51) Int. Cl. G06K 9/00

(52) U.S. Cl. CPC G06K 9/00442
USPC 382/176; 709/203

(57) ABSTRACT

Systems and methods for processing an electronic document are provided. The method comprises segmenting the electronic document based on content of the electronic document and structuring the segmented electronic document into a format for displaying on a reading terminal based on a request received from the reading terminal.

### CROSS REFERENCE TO RELATED APPLICATION

This application claims the benefits of priority to Chinese Patent Application No. 201110445056.4, filed on Dec. 27, 2011, the entire contents of which are incorporated in this application by reference.

### TECHNICAL FIELD

The present application relates to computing field, in particularly to a method, a server, a reading terminal and a system for processing an electronic document.

### BACKGROUND

With the development of network technology and mobile devices, electronic documents become more and more popular. Readers are becoming used to read electronic documents through various reading terminals such as computer monitors, mobile phones, PDAs or the like.

Currently there are many electronic documents having different formats available on the Internet and on various reading terminals. A particular format suitable for a particular reading terminal may not be suitable for display on another reading terminal or may not even readable by another reading terminal. Typically, when a reader wants to read an electronic document, the reader needs to download the electronic document to a local device and then open the electronic document using a corresponding reader that supports the format of the electronic document. With many different formats currently in use, this process is quite inconvenient.

Therefore, it is desirable to provide an system and a method to customize an electronic document in a format that are suitable for a reading terminal that requests the document.

### SUMMARY

One embodiment of the invention involves a method for processing an electronic document. The method comprises segmenting the electronic document based on content of the electronic document and structuring the segmented electronic document into a format for displaying on a reading terminal based on a request received from the reading terminal.

Another embodiment involves a server for processing an electronic document. The server comprises a memory and one or more processors communicatively connected to the memory. The one or more processors are configured to segment the electronic document based on content of the electronic document and structure the segmented electronic document into a format for displaying on a reading terminal based on a request received from the reading terminal.

Another embodiment involves a reading terminal. The reading terminal comprises a processor configured to send a request to a server for displaying an electronic document on the reading terminal, the request comprising information associated with the reading terminal; and receive from the server a segmented electronic document having a format for displaying on the reading terminal. The reading terminal also comprises a display device for displaying the received segmented electronic document.

Another embodiment involves a system comprising the above described sever and reading terminal.

The preceding summary and the following detailed description are exemplary only and do not limit the scope of the claims.

### BRIEF DESCRIPTION OF THE DRAWINGS

The accompanying drawings, which are incorporated in and constitute a part of this specification, in connection with the description, illustrate various embodiments and exemplary aspects of the disclosed embodiments. In the drawings:

FIG. 1 is a flow chart illustrating an exemplary method for processing an electronic document according to an embodiment of the present application;

FIG. 2 is a flow chart illustrating an exemplary method for processing an electronic document according to another embodiment of the present application;

FIG. 3 is a schematic diagram illustrating an exemplary server for processing an electronic document according to an embodiment of the present application;

FIG. 4 is a schematic diagram illustrating an exemplary server for processing an electronic document according to another embodiment of the present application;

FIG. 5 is a schematic diagram illustrating an exemplary reading terminal according to an embodiment of the present application;

FIG. 6 is a schematic diagram illustrating an exemplary system for processing and reading an electronic document according to an embodiment of the present application; and

FIG. 7 is a schematic diagram illustrating an exemplary system for processing and reading an electronic document according to another embodiment of the present application.

### DESCRIPTION OF THE EXEMPLARY EMBODIMENTS

Reference will now be made in detail to exemplary embodiments, examples of which are illustrated in the accompanying drawings. When appropriate, the same reference numbers are used throughout the drawings to refer to the same or like parts.

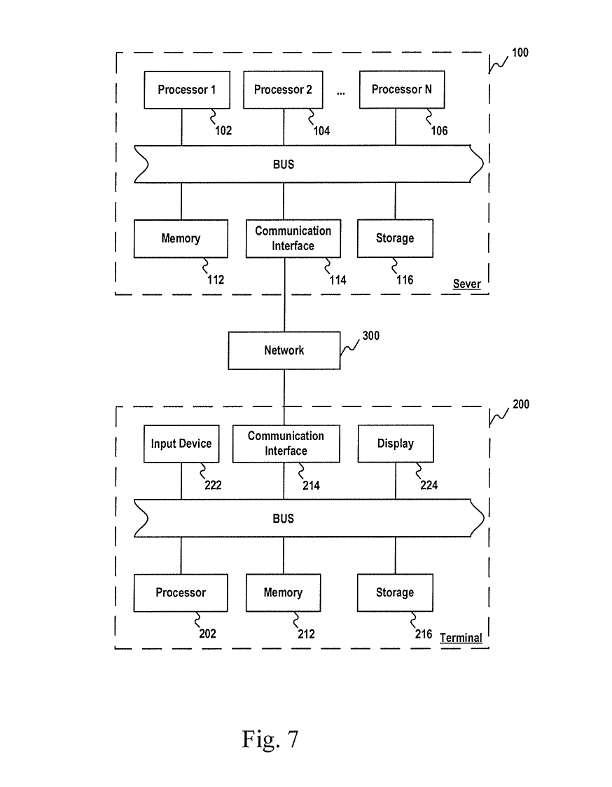

FIG. 7 is a schematic diagram illustrating an exemplary system for processing and reading an electronic document, consistent with some disclosed embodiments. FIG. 7 shows an online system where a reading terminal (hereinafter “terminal”) 200 communicatively connects with a server 100 via a network 300. Information may be exchanged between server 100 and terminal 200.

Server 100 may include a general purpose computer, a computer cluster, a mainstream computer, a computing device dedicated for providing online contents, or a computer network comprising a group of computers operating in a centralized or distributed fashion. As shown in FIG. 7, server 100 may include one or more processors (processors 102, 104, 106 etc.), a memory 112, a storage device 116, a communication interface 114, and a bus to facilitate information exchange among various components of server 100. Processors 102-106 may include a central processing unit (“CPU”), a graphic processing unit (“GPU”), or other suitable information processing devices. Depending on the type of hardware being used, processors 102-106 can include one or more printed circuit boards, and/or one or more microprocessor chips. Processors 102-106 can execute sequences of computer program instructions to perform various methods that will be explained in greater detail below.

Memory 112 can include, among other things, a random access memory (“RAM”) and a read-only memory (“ROM”). Computer program instructions can be stored, accessed, and read from memory 112 for execution by one or more of processors 102-106. For example, memory 112 may store one or more software applications. Further, memory 112 may store an entire software application or only a part of a software application that is executable by one or more of processors 102-106. It is noted that although only one block is shown in FIG. 7, memory 112 may include multiple physical devices installed on a central computing device or on different computing devices.

In some embodiments, storage device 116 may be provided to store a large amount of data, such as databases containing digital publications, electronic documents, contents files, multimedia files, etc. Storage device may also store software applications that are executable by one or more processors 102-106. Storage device 116 may include one or more magnetic storage media such as hard drive disks; one or more optical storage media such as computer disks (CDs), CD-Rs, CD±RWs, DVDs, DVD±Rs, DVD±RWs, HD-DVDs, Blu-ray DVDs; one or more semiconductor storage media such as flash drives, SD cards, memory sticks; or any other suitable computer readable media.

Communication interface 114 may provide wired or wireless communication connections such that server 100 may exchange data with other computers, such as terminal 200. For example, server 100 may be connected to network 300. Network 300 may include LAN, WAN, VPN, Internet, telecommunication network, etc. Terminal 200 and server 100 may be located in different geographical sites.

Terminal 200 may include a general purpose computer such as a desktop computer, a laptop computer, etc. Terminal 200 may also include a portable computer such as a mobile phone, a tablet, an e-book reader, or other mobile devices. Terminal 200 may include a processor 202 such as a CPU, a memory 212 such as a RAM and/or a ROM, a storage device 216, a communication interface 214, an input device 222, a display 224, and a bus to facilitate information exchange among various components of terminal 200. Storage device 216 may include one or more magnetic storage media such as hard drive disks; one or more optical storage media such as computer disks (CDs), CD-Rs, CD±RWs, DVDs, DVD±Rs, DVD±RWs, HD-DVDs, Blu-ray DVDs; one or more semiconductor storage media such as flash drives, SD cards, memory sticks; or any other suitable computer readable media. Communication interface 214 may include wired and/or wireless communication devices such as an Ethernet adaptor, a WiFi adaptor, a Bluetooh module, a telecommunication module, etc. to connect terminal 100 to network 300.

In some embodiments, input device 222 and display device 224 may be coupled to processor 202 through appropriate interfacing circuitry. In some embodiments, input device 222 may include a hardware keyboard, a keypad, a mouse, a touchpad, or a touch screen, through which a user may input information to terminal 200. Display device 224 may include one or more display screens that display media information, such as electronic documents, to the user.

Some embodiments provide systems and methods for processing an electronic document. An exemplary system is shown in FIG. 7, in which server 100 is connected with terminal 200 via network 300 such that terminal 200 may send requests to server 100 and receive data (e.g., electronic documents) from server 100 and display the content of the data on display 224. As used herein, an electronic document may include subject matter encoded in digital data that are readable, viewable, or sensible by a user. For example, an electronic document may include text and/or image contents, motion picture contents of a movie, audio contents of music or speech, and a combination thereof.

In some embodiments, terminal 200 may receive a request from a user (e.g., through input device 222) to obtain an electronic document from server 100. Terminal 200 may then send a request for the electronic document to server 100 via network 300. Server 100, upon receiving the request, may obtain the requested electronic document from a database. The electronic document may be stored on the server in such a way that different types of information are segmented into different portions. Server 100 may retrieve from the request received from terminal 200 certain information associated with terminal 200, such as screen resolution, operating system, memory space, screen type, processing power, etc., and customize the electronic document to suit for the particular terminal that requests the document.

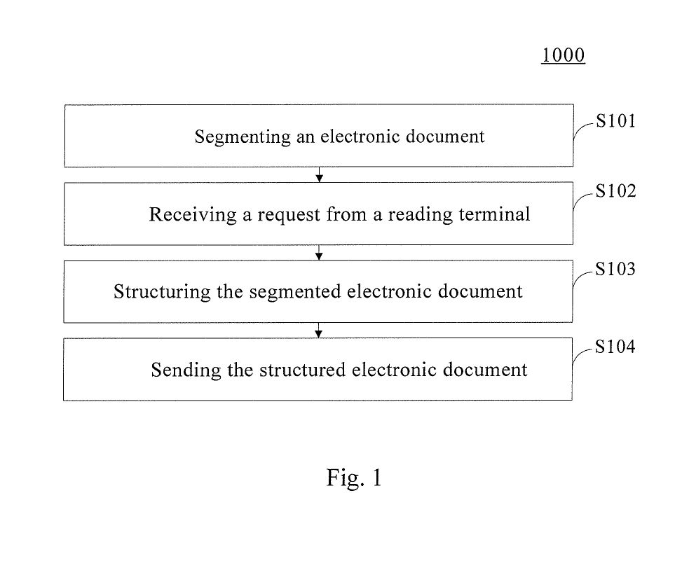

The present application provides a method 1000 for processing one or more electronic documents comprising the following steps as shown in FIG. 1. Method 1000 includes step S101, in which a server (e.g., server 30 in FIG. 3 or server 100 in FIG. 7) receives and segments an electronic document based on content of the electronic document. The segmented document may be stored on the server. For example, the server may segment the received document into text information and non-text information according to contents thereof, and then store the text information in a text format, and store the non-text information in an image format.

In this way, all received electronic documents having various formats may be segmented in accordance with the above method, and then the text information and non-text information may be stored in generic text format and image format, respectively.

In addition, after the server segments the received document and stores the segmented document, server 30 may backup the originally received electronic document, such that the original document is available upon requested.

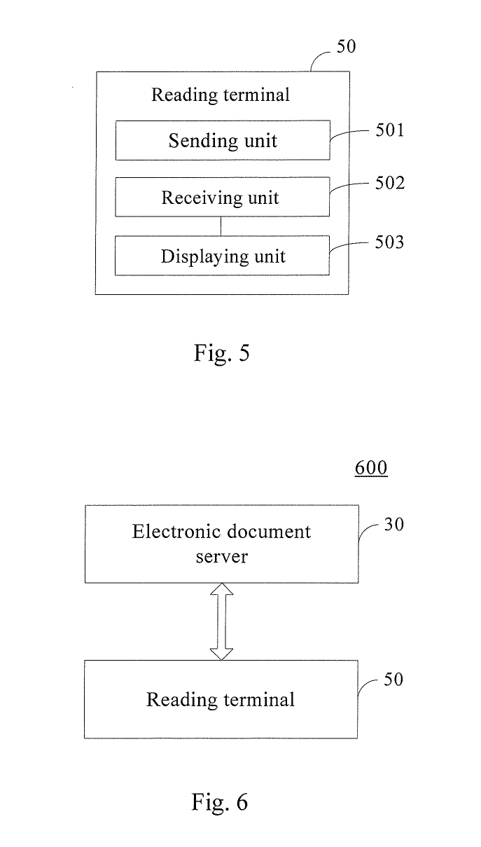

In Step S102, server 30 may receive a request message from a reading terminal 50, which will be discussed in reference to FIG. 5. In some embodiments, the request message received by server 30 may comprise relevant information on the reading terminal, such as, screen size, operating system, display resolution, internal memory of the reading terminal, colors and fonts supported by the reading terminal or the like. Server 30 may, based on the received information, adjust corresponding matching policies for displaying the document on the reading terminal.

In Step S103, server 30 may structure the segmented contents/information of the electronic document to form a file with a display format suitable for the reading terminal. For example, server 30 may search and obtain the corresponding segmented information according to the received request message, and then may structure the found information as a file with a display format suitable for reading terminal 50. In this way, server 30 can structure information of the electronic document into a formatted file according to respective requirements of various reading terminals, and then sends the structured file to the reading terminals.

In Step S104, server 30 may send the structured file to the reading terminal so that the electronic document may be displayed on the reading terminal.

With the above method, no matter what format the original electronic document has, the electronic document can be segmented according its contents. The server may then structure information of the electronic document to form a file with a display format suitable for a requesting reading terminal, so that various reading terminals can conveniently read various formats of electronic documents online.

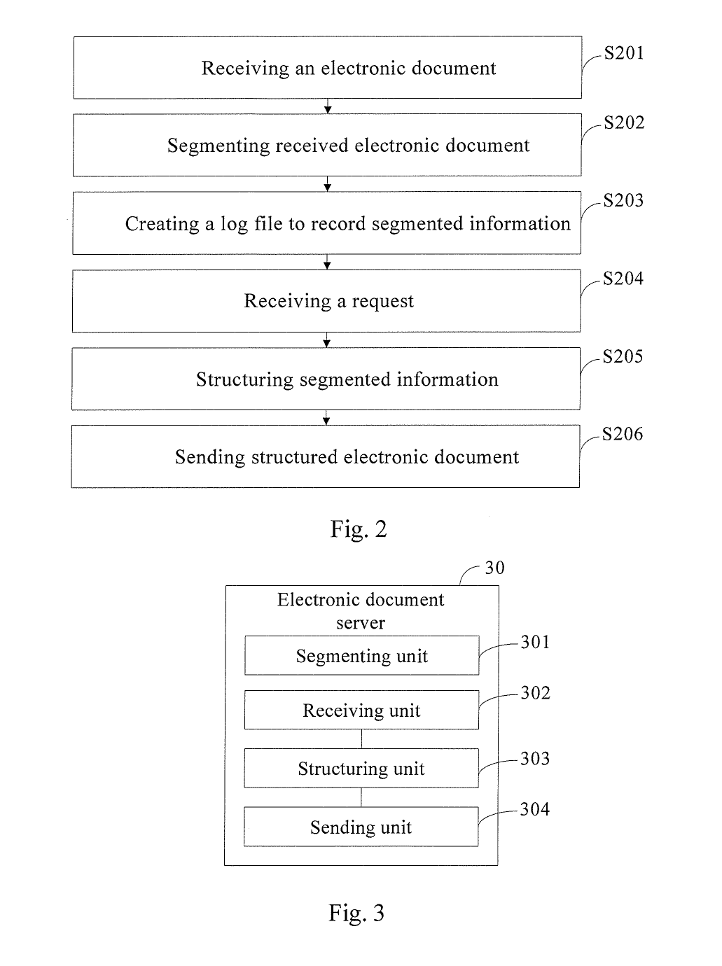

Another embodiment of the present application provides a method for processing electronic document comprising the following steps as shown in FIG. 2.

In Step S201, a user may upload an electronic document to server 30 and server 30 may receive the document. The user may upload the electronic document to server 30 through a device such as a reading terminal 50. Users may provide electronic documents stored on the server.

In Step S202, server 30 may segment the received document according to its contents and store the segmented document. For example, the server may segment the received document into text information and non-text information according to its contents; and then store the text information in a text format, and store the non-text information in an image format.

In Step S203, server 30 may create a log file to record segmented contents information of the electronic document. In some embodiments, the log file may include a resource log XML (eXtensible Markup Language) file created by the server, which may record address for storing the segmented contents and necessary layout information. For example, the follows is an exemplary XML model of the resource log file created by the server.

<?xml version=“1.0”?>
<doucument id=“number” title=“title” pageno=“number of pages” location=“address

of source file”>

<page id=“1”>
<text src=“dir/text/p1.txt”>
<Line id=“number” rowHeight=“row height” Font=“font” Size=“size” color=“color”

Left=“distance from the left side” start=“starting location” end=“ending
location”></Line>

<Line id=“number” rowHeight=“row height” Font=“font” Size=“size” color=“color”

Left=“distance from the left side” start=“starting location” end=“ending
location”></Line>

...
</text>
<image src=“dir/image/pic.jpg” Left=“distance from the left side” Top=“distance

from the top side” width=“width” height=“height”></image>

<table src=“ dir/table/tb.bmp” Left=“distance from the left side” Top=“distance from

the top side” width=“width” height=“height”></table>

...
</page>
<page id=“2”>
<text src=“ dir/text/p2.txt”>
<Line id=“number” rowHeight=“row height” Font=“font” Size=“size” color=“color”

Left=“distance from the left side” start=“starting location” end=“ending
location”></Line>

<Line id=“number” rowHeight=“row height” Font=“font” Size=“size” color=“color”

Left=“distance from the left side” start=“starting location” end=“ending
location”></Line>

...
...
</text>
<image src=“dir/image/pic.jpg” Left=“distance from the left side” Top=“distance

from the top side” width=“width” height=“height”></image>

<formula src=“dir/table/tb.bmp” Left=“distance from the left side” Top=“distance

from the top side” width=“width” height=“height”></formula>

...
</page>
...
...
< /doucument >

The above XML file records the detailed address on server 30 for storing segmented information of the electronic document and necessary layout information.

In this XML file, the electronic document comprises one or more page, and each page comprises basic information such as texts, images, tables, formulas, graphs, charts, special characters, fontworks or the like. The text, printable symbols, characters or the like are set in a plain text file, and other contents are represented by images.

There are some correlations between the text, characters, symbols in the plain text file and those of original format file. Each word, character and symbol is arranged in form of rows in the original document regardless of such correlations. Therefore, tags of the XML resource log file are determined according to a hierarchical relationship of the above model.

The tags <doucument></doucument> represent this electronic document, four attributes of the tag respectively represent the electronic document number, title, number of pages and storage location of a backup file. The “number id” attribute is a key attribute for identifying the electronic document, since “id number” of each document is unique.

The tags <page></page> represent page of the text and has an attribute “id” representing page number, which is a unique identification for distinguishing the page from other pages of the document.

There are multiple paratactic hierarchies between tags <page></page>, such as <text></text>, <image></image>, <table></table>, <formula></formula> or the like, of which appearance means there are corresponding contents in the page with the id number. The attribute <text> describes the location of the text contents between tags on the server. Since contents corresponding to other tags are represented by images, their attribute settings are the same, and only keywords of tags are different from each other. Such attribute, such as attributes of <image> respectively indicate resource's (such as image's) address on the server, location from the page's left side and top side of the original document, and the width and height of the image, which is also true of other attributes.

There are rows between the tags <text></text>, but the tag <Line> indicates lines of the original text rather than lines of the text file. In addition, contents between a pair of tags <Line></Line> are obtained from the text file indicated by attributes of <text>. Therefore, contents between each pair of tags <Line></Line> are corresponding to a piece of text of the text file. Attributes of <Line> are as follows: “id” is an identification number of line, “rowHeight” is the height of a row, “Font” is the font, “Size” is the font size, “color” is the font color, the combination of “start” and “end” is the location of characters between the <Line></Line> in the text file, the text file is the file indicated by attributes of the higher level tag <text>.

The log file records storage location of segmented electronic document thereof on the server and necessary layout information in detail, which may not only facilitate the retrieve of the documents for a user, but also restore and restructure the electronic document better through the log file.

In Step S204, server 30 may receive the request message from the reading terminal. In some embodiments, the request message may comprise relevant information on the reading terminal, such as screen size, operating system, resolution, internal memory of the reading terminal, colors and fonts supported by the reading terminal or the like. Server 30 may adjust corresponding matching policies for displaying based on the received information.

In Step S205, server 30 may structure the segmented information to form a file with a display format suitable for the reading terminal. For example, server 30 may find corresponding segmented information on the electronic document according to the received request message, and then may structure the found information as a file in a format suitable for display on the reading terminal.

In some embodiments, server 30 may obtain the corresponding information of the electronic document according to the user's request message and the reading terminal's requirement, and structure a display model XML file, which may be sent to the reading terminal. For example, one model of the display model XML file is illustrated below.

<?xml version=“1.0”?>
<block id=“identification”>
<page>
<Line id=“number” type=“text” rowHeight=“height of row” Font=“font” Size=“size”

color=“color” Left=“ distance from the left side” align=“centered”>text content</Line>

<Line id=“number” type=“image” src=“ dir/image/pic.jpg” Left=“distance from the

left side” Top=“distance from the top side” width=“width” height=“height” ></Line>

<Line id=“number” type=“text” rowHeight=“row height” Font=“font” Size=“size”

color=“color” Left=“distance from the left side” align=“bottom-aligned” >text
content</Line>

</page>
...
</ block >

This XML file represents the structured format which is obtained through structuring the segmented information of the original document according to the requirement of the reading terminal, and will be used as fundamental units for the reading request and network transmission. This XML file will be further explained as follows.

Contents requested by the reading terminal is structured and transmitted by blocks. Information on each block comprises one or more pages to be displayed by the reading terminal. Each page is structured by lines. Each line defines the showing style of corresponding characters.

The tags <block></block> indicate size of content transmitted in one time, attribute “id” thereof indicates an identification of a block, and “id” of each block is unique and a key code for distinguishing from other blocks. The next level tags are <page></page> which indicates information on each page for satisfying the requirements of the reading terminal. There are contents consisted of multiple pairs of tags <Line></Line> between pair of tags <page></page>. Common attributes of <line> comprise “id” and “type”, wherein, the “id” indicates line number and the “type” indicates content properties represented by the current line. Other attributes vary depending on values of the attribute “type.” The attribute “type” includes two values, “text” and “image”. When a certain line displays text, the value of the attribute “type” can be “text.” Other attributes “rowHeight” is the height of a row, “Font” is the font, “Size” is the font size, “color” is the font color, “Left” is the distance from the start of character string to the left side of the page, “align” is font aligning format on the vertical direction which has three values, i.e., “top-aligned”, “centered” and “bottom-aligned”. Contents between other tags are character string to be displayed by a line with number id. When a certain line displaying an image, the value of the attribute “type” can be “image.” Other attributes “src” is resource (such as the image) address on the server, “Left” is the distance from the image to the left side of the page, “Top” is the distance from the image to the top side of the page, “Width” and “Height” respectively indicate the width and height of the image.

The model XML file discussed above may be a temporary file created according to the request message of the reading terminal. The server may structure information on the original file by blocks according the request message of the reading terminal and other information, such as screen size, operating system, resolution, internal memory or the like, and then sends the restructured file to the reading terminal to be displayed. The above-described XML model is an example and will vary depending on various reading terminals, and it is assumed that all attributes mentioned in tags are supported by the reading terminal.

In addition, the document can be displayed in flow mode through structuring the original file by blocks. The size of blocks may vary depending on change of requirement of reading terminals, such as network flow, memory size or the like.

In Step S206, server 30 may send structured file to the reading terminal so that the reading terminal may display the electronic document.

Hereinafter, the electronic document server 30 according to an embodiment of the present application will be further discussed in reference to FIG. 3. As shown in FIG. 3, server 30 comprises a segmenting unit 301, a receiving unit 302, a structuring unit 303, and a sending unit 304.

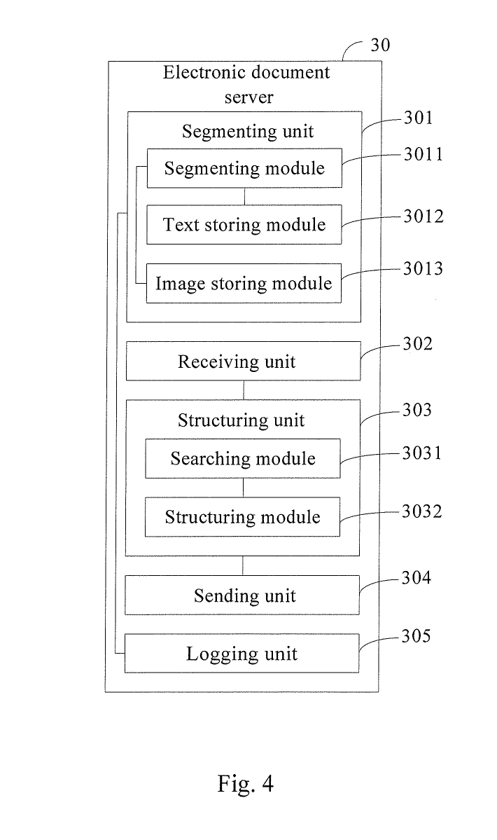

The segmenting unit 301 may be configured to segment received document according to its contents. As mentioned above, the segmented document may be stored on server 30. As shown in FIG. 4, segmenting unit 301 may further comprise a segmenting module 3011 configured to segment received document into text information and non-text information according to its contents, a text storing module 3012 may be configured to store the text information in a text format, and an image storing module 3013 may be configured to store the non-text information in an image format.

The receiving unit 302 may be configured to receive a request message from a reading terminal.

The structuring unit 303 may be configured to structure segmented information of the electronic document to form a file with a display format suitable for the reading terminal. Restructuring unit 303 may further comprise a searching module 3031 and a structuring module 3032. In some embodiments, searching module 3031 may be configured to find corresponding segmented information on the electronic document according to the request message. Structuring module 3032 may be configured to structure segmented information of the electronic document as a file having a format suitable for display on the reading terminal.

Sending unit 304 may be configured to send the XML file to the reading terminal so that the electronic document may be displayed on the reading terminal.

In addition, electronic document server 30 may further comprise a logging unit 305 configured to create a log file to record segmented contents information of the electronic document. The request message received by server 30 may comprise relevant information of the reading terminal.

FIG. 5 shows an exemplary reading terminal 50, according to some embodiments. In FIG. 5, reading terminal 50 may comprise a sending unit 501, a receiving unit 502, and a displaying unit 503. Sending unit 501 may be configured to send a request message comprising relevant information thereof to an electronic document server (e.g., server 30 or server 100). Receiving unit 502 may be configured to receive a file having a format suitable for display on reading terminal 50 from the server. Displaying unit 503 may be configured to display the file.

FIG. 6 schematically shows a block diagram of an exemplary electronic document processing and reading system according to an embodiment of the present application. As shown in FIG. 6, system 600 may comprise server 30 (or server 100) and the reading terminal 50 (or reading terminal 200).

The embodiments of the present invention may be implemented using certain hardware, software, or a combination thereof. In addition, the embodiments of the present invention may be adopted to a computer program product embodied on one or more computer readable storage media (comprising but not limited to disk storage, CD-ROM, optical memory and the like) containing computer program codes.

In the foregoing descriptions, various aspects, steps, or components are grouped together in a single embodiment for purposes of illustrations. The disclosure is not to be interpreted as requiring all of the disclosed variations for the claimed subject matter. The following claims are incorporated into this Description of the Exemplary Embodiments, with each claim standing on its own as a separate embodiment of the disclosure.

Moreover, it will be apparent to those skilled in the art from consideration of the specification and practice of the present disclosure that various modifications and variations can be made to the disclosed systems and methods without departing from the scope of the disclosure, as claimed. Thus, it is intended that the specification and examples be considered as exemplary only, with a true scope of the present disclosure being indicated by the following claims and their equivalents.

What is claimed is:

1. A method for processing an electronic document, comprising:
segmenting the electronic document based on content of the electronic document; and
structuring the segmented electronic document into a format for displaying on a reading terminal based on a request received from the reading terminal.

2. The method according to claim 1, wherein segmenting the electronic document comprises:
segmenting the electronic document into text information and non-text information; and
storing the text information in a text format and storing the non-text information in an image format.

3. The method according to claim 2, further comprising:
creating a log file to record the segmented text information and non-text information.

4. The method according to claim 1, further comprising:
receiving the request from the reading terminal, the request comprising information associated with the reading terminal.

5. The method according to claim 4, wherein structuring the segmented electronic document comprises:
obtaining segmented information corresponding to the request in the segmented electronic document; and
structuring the segmented information into the format for displaying on the reading terminal based on the information associated with the reading terminal.

6. A server for processing an electronic document, comprising:
a memory; and
one or more processors communicatively connected to the memory, wherein the one or more processors are configured to:
segment the electronic document based on content of the electronic document; and
structure the segmented electronic document into a format for displaying on a reading terminal based on a request received from the reading terminal.

7. The server according to claim 6, wherein the one or more processors are further configured to:
segment the electronic document into text information and non-text information; and
store the text information in a text format in the memory and store the non-text information in an image format in the memory.

8. The server according to claim 7, wherein the one or more processors are further configured to:
create a log file to record the segmented text information and non-text information.

9. The server according to claim 6, wherein the one or more processors are further configured to:
obtain segmented information corresponding to the request in the segmented electronic document, the request comprising information associated with the reading terminal; and
structure the segmented information into the format for displaying on the reading terminal based on the information associated with the reading terminal.

10. A reading terminal, comprising:
a processor configured to:
send a request to a server for displaying an electronic document on the reading terminal, the request comprising information associated with the reading terminal; and
receive from the server a segmented electronic document having a format for displaying on the reading terminal; and
a display device for displaying the received segmented electronic document.
